(19) United States
(12) Patent Application Publication
(10) Pub. No.: US 2010/0143742 A1
(43) Pub. Date: Jun. 10, 2010

(54) WEAR-RESISTANT CASTINGS AND METHOD OF FABRICATION THEREOF

(76) Inventors: Igor Tsypine, St-Laurent (CA); Rafael Perlin, Montreal (CA)

Correspondence Address: GOUDREAU GAGE DUBUC, 2000 MCGILL COLLEGE, SUITE 2200, MONTREAL, QC, H3A 3H3, CA

(21) Appl. No.: 12/532,276

(22) PCT Filed: Apr. 18, 2008
(86) PCT No.: PCT/CA08/00720

§ 371 Date: Sep. 21, 2009

(30) Foreign Application Priority Data
Apr. 20, 2007 (CA) 2,585,688

(51) Int. Cl. B32B 3/00; B22D 23/00; B22D 25/00; B32B 15/01; B32B 15/06; B32B 15/08; B32B 15/18; C08L 75/04

(52) U.S. Cl. 428/600; 148/538; 164/76.1; 428/615; 428/681; 428/684; 524/589

(57) ABSTRACT

A wear resistant casting and method of fabrication thereof, the casting comprising inserts embedded in a matrix; each insert having a form such that a ratio A/B in any mutually perpendicular section that passes through the centre of mass of the insert is comprised between 0.4 and 2.5, and a distance C between two insert is at least two times smaller that a width thereof; the inserts forming at least one grid.

### FIELD OF THE INVENTION

The present invention relates to wear-resistant castings. More specifically, the present invention is concerned with wear-resistant castings and method of fabrication thereof.

### BACKGROUND OF THE INVENTION

One of many challenges for manufacturer of machine parts that are subjected to intensive abrasive wear, especially in conditions where abrasion wear is combined with impact loads, is to ensure a satisfactory longevity of these particular machine parts. Usually additional considerations, such as the fixing technique of the liner and/or the maintenance facility, for example, are also to be taken to account.

Various technical solutions presently used in mining and similar industries to protect machine parts from wear are able to meet, to some degree, these requirements, by using materials that have good abrasive and/or impact resistance, design flexibility, and good weldability.

Austenitic steels with a 13% Mn by weight, for example, have very good toughness and strength and are used in extremely hard wear conditions, including impact wear conditions that occur for example in conical and jaw crushers, or in excavator teeth. However, these steels have a relatively low hardness (about 220 HB) and therefore a low abrasive resistance (see Metals Handbook, 10th edition, 1990, ASM International, Material Park, Ohio). Moreover, due to their poor weldability, they require special welding rods and higher welding time and general costs.

Hi-Cr cast irons, described for example in G. Laird, R. Gundlach, K. Rohrig. Abrasion-Resistant Cast Iron Handbook, AFS, Illinois, 2000, have very good hardness and abrasive wear resistance resulting from a microstructure comprising extremely hard chromium carbides dispersed in a martensite or martensite-austenite matrix. However, this increased hardness leads to a very low ductility and for this reason the use of these materials in impact intensive conditions is either counterproductive or limited. Moreover, these cast irons cannot be easily welded and, therefore, have to be fixed on the protected surface by bolting.

Another group of wear resistant materials comprises low carbon heat-treated steels like, for example, Hardox™, AR steel, Astralloy™. They have high strength, good toughness, and good hardness (up to 550 HB) while remaining weldable to a certain extent. As compared to ferrite and pearlite steels, they demonstrate an increased wear resistance, however, they are significantly inferior to Hi-Cr cast irons from a wear resistance point of view. Their microstructure lacks carbides or other phases comparable, from the hardness point of view, with the quartz, which is known as one of the widest spread wear causing components of all abrasive materials. Moreover, these steels can exclusively be used to cover flat surfaces, since they are produced by rolling methods.

There have been attempts to combine the properties of tough, ductile materials, such as steels, and highly wear resistant but brittle materials, like Hi-Cr cast irons, by laminating such materials together into one product. Brazed laminated plates consist of a massive Hi-Cr cast plate jointed with a mild steel under-plate by brazing. Such products combine the high wear resistance of Hi-Cr cast iron with the good weldability properties of mild steel. However the brittleness of the Hi-Cr cast iron reappears in the top part of this products and the brazed bond between two parts may fail. There are well reported cases where chunks of the Hi-Cr cast iron block were separated from the laminated plate, resulting in serious damages to the machinery down the production line and, consequently, significant downtimes. Moreover, brazed laminated plates cannot be manufactured to fit curved surfaces or to have a variable thickness.

Popular hard faced plates, such as provided by the company BROSPEC INC. for example, consist of mild steel flat bars covered by welding with alloys in which carbides are dispersed in a mainly austenitic matrix. These products have a good weldability but they inherit drawbacks from the automatic welding process used for their manufacturing. First, they may only be placed on flat surfaces. Secondly, the total thickness, even in multilayer product, is very limited (usually ½″ up to ¾″) by metallurgical reasons. Third, the wear resistant layer has high internal stresses due to a number of factors including high thermal gradient, different thermal coefficients of the mild steel and the alloy itself as well as high cooling speed. These stresses eventually cause cracking of the hard faced layer with subsequent crumbling of the layer. After welding, although the austenitic microstructure is far from being optimal, there is no possibility to improve it by heat treatment because of those internal stresses and the divergence of the mechanical properties.

Another group of technical solutions to increase the wear resistance of the machinery includes placing hard inclusions made of Hi-Cr cast iron or tungsten carbides in selected parts of the machinery. For example, U.S. Pat. No. 5,439,751 describes an ore pellet cast grate cooler side plate having a bottom surface containing embedded insert made of Hi-Cr cast iron.

U.S. Pat. No. 5,081,774 and U.S. Pat. No. 5,066,546 describe composite casting of an excavator tooth in which the critical wear areas are protected by Hi-Cr cast iron inserts or other material.

U.S. Pat. No. 1,926,770 proposes to insert tungsten carbide items in grey cast iron products.

The aforementioned solutions prove inefficient in protecting sophisticated structures, concave or convex surfaces and super-thick parts or pieces having a variable thickness.

### SUMMARY OF THE INVENTION

More specifically, there is provided a wear resistant casting, comprising a matrix and inserts embedded in the matrix; each insert having a form such that a ratio A/B in any mutually perpendicular section that passes through the centre of mass of the insert is comprised between 0.4 and 2.5, and a distance C between two insert is at least two times smaller that a width thereof; the inserts forming at least one grid.

There is further provided a method for manufacturing wear resistant castings, comprising the steps of forming at least one grid of compact elements and inserting at least one grid into a jacket; forming at least one grid comprising compact elements having a form such that a ratio A/B in any mutually perpendicular section that passes through the centre of mass of the insert is comprised between 0.4 and 2.5, and a distance C between two insert is at least two times smaller that a width A, B thereof.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a) a schematic top view; b) a first cross section; and c) a second section of a casting according to an embodiment of a first aspect of the present invention;

FIG. 2 is a) a schematic top view and b) a section view of a casting according to another embodiment of a first aspect of the present invention;

FIG. 3 are views of a casting according to still another embodiment of a first aspect of the present invention;

FIG. 4 are sections of castings according to further embodiments of a first aspect of the present invention;

FIG. 5 are views of a grid according to an embodiment of the present invention

FIG. 6 illustrate shapes of inserts for a casting according to an embodiment of the present invention;

FIG. 7 is a perspective top view of the FIG. 1 casting.

FIG. 8 shows inclusions in a casting according to an embodiment of the present invention;

FIG. 9 show a) a concave, b) a convex, and c) a concave-convex plate according to an embodiment of the present invention.

FIG. 10 shows a casting having a back plate, according to an embodiment of a first aspect of the present invention;

FIG. 11 is a) a cross section view; b) a schematic top view section of a casting according to an embodiment of a first aspect of the present invention; and

FIG. 12 is a) a schematic top view; b) a first cross section; c) a second section; d) a third section; and e) a grid of a casting according to an embodiment of a first aspect of the present invention.

### DESCRIPTION OF ILLUSTRATIVE EMBODIMENTS

The present invention is illustrated in further details by the following non-limiting examples.

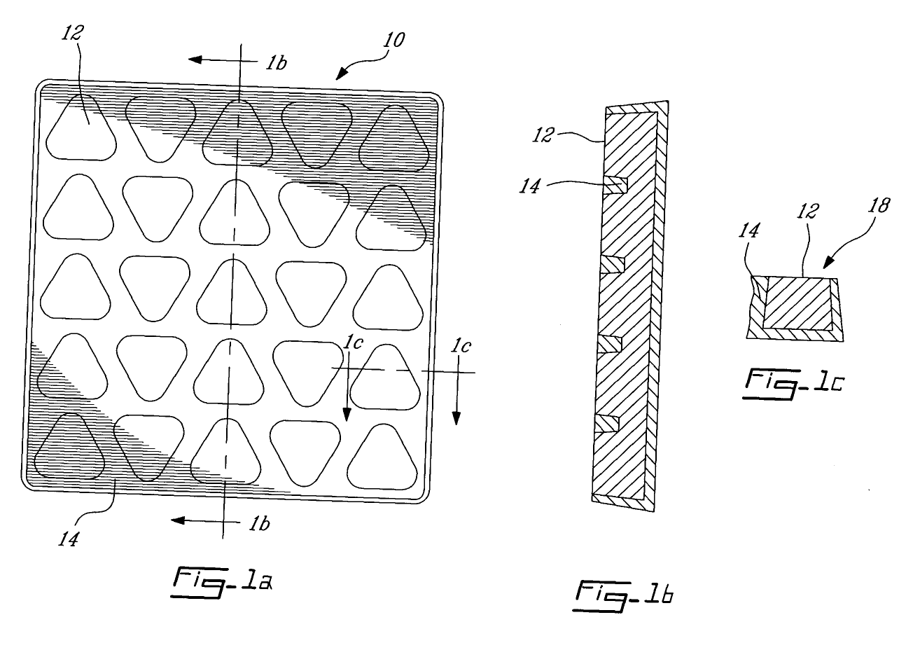

As illustrated in the FIGS. 1 to 5 of the appended drawings, a casting 10 generally comprises a grid formed of a plurality of inserts 12, embedded in a matrix 14.

The matrix 14 is made of a ductile material, such as ductile ferro alloy for example. The inserts 12 are made of an abrasion and impact resistant material, such as Hi-Cr white cast-iron, for example.

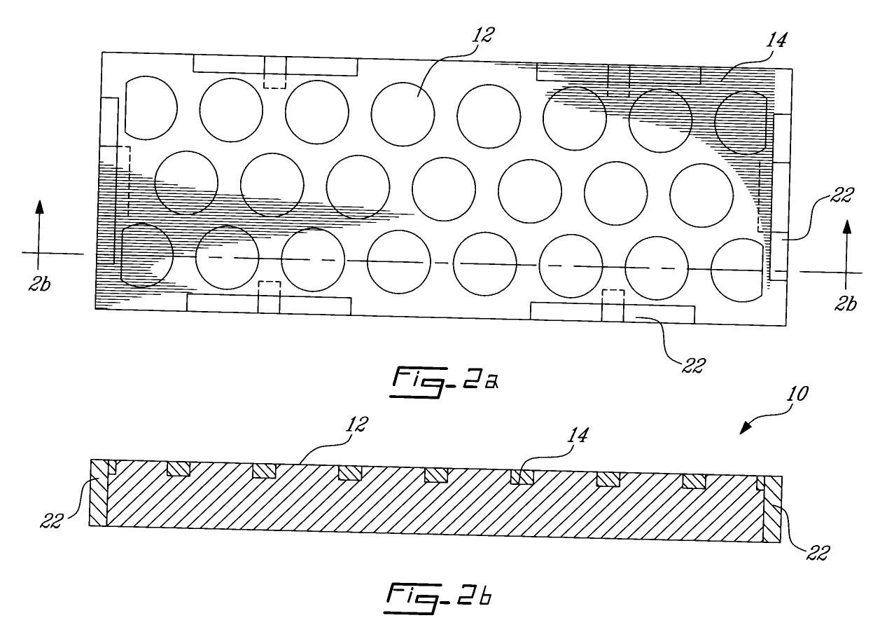

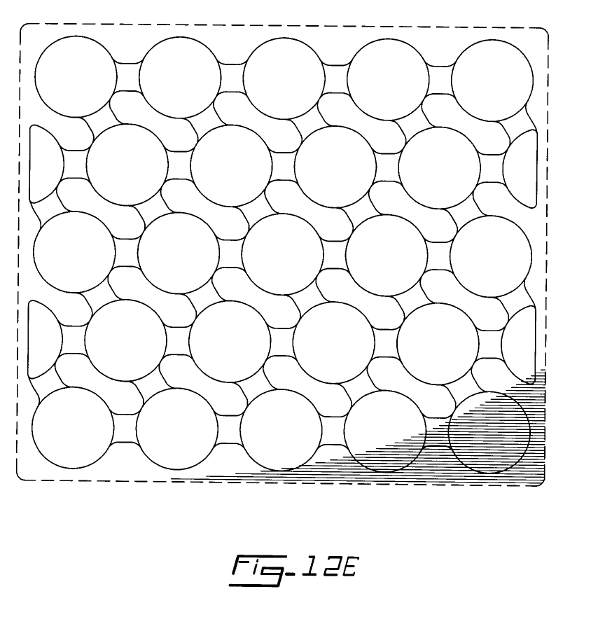

The inserts 12 are compact elements, formed in the plan view as circles (FIGS. 2, 12a), triangles (FIG. 1), squares, rectangles, Y or T-forms (FIGS. 6a-d), or combinations for example (FIGS. 6e-h). In the same plate 10, inserts 12 may have various shapes.

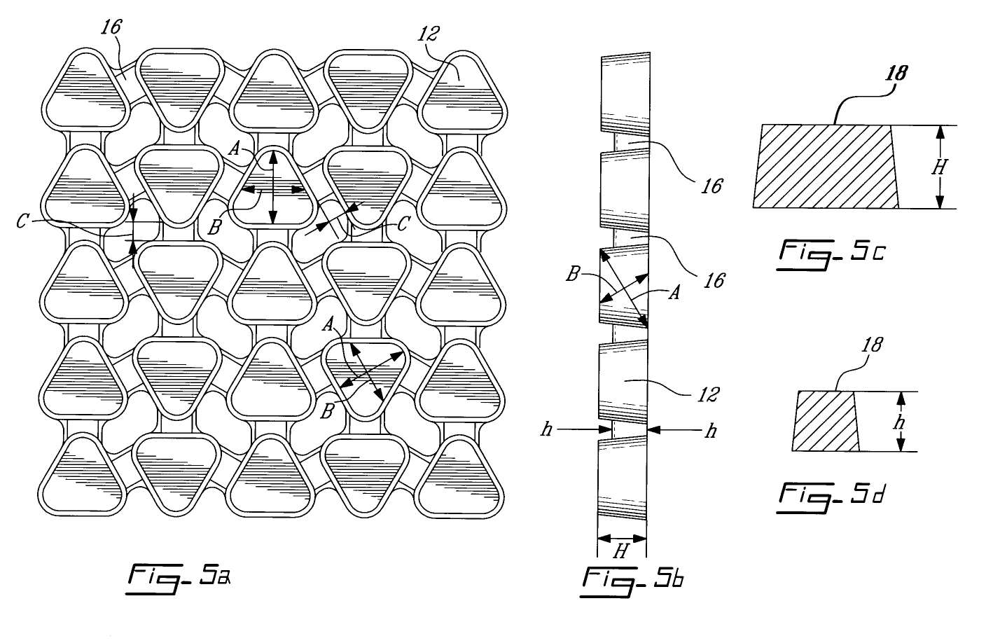

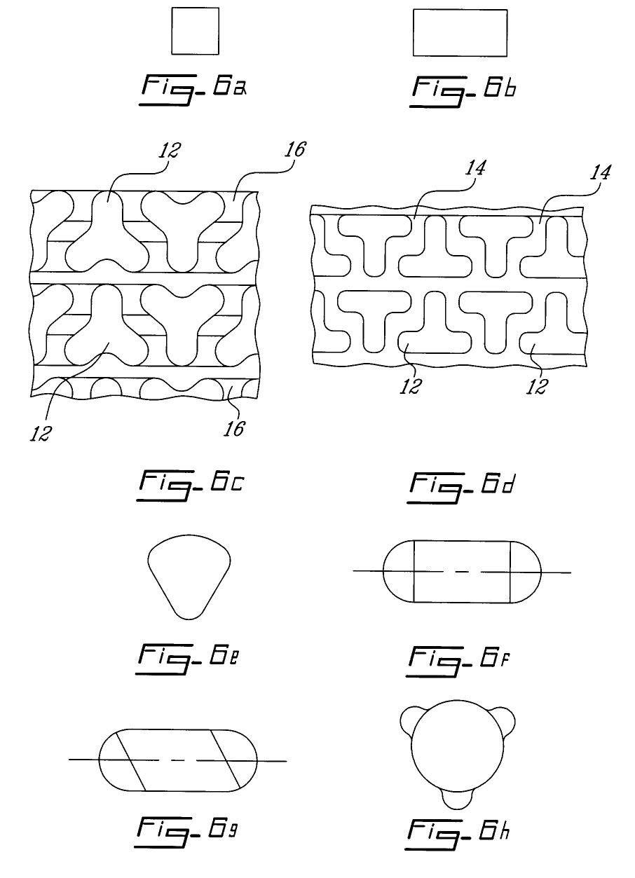

As best seen in FIG. 5a, the length to the width ratio (A/B) in any mutually perpendicular section crossing the centre of gravity of a given insert 12 is comprised in the range between 0.4 and 2.5.

Moreover, the distance C between two inserts 12 is at least two times smaller that their width, i.e. A/C>2 and B/C>2 (see FIG. 5 (a)), so that the softer matrix material between the inserts is protected by a “shadow effect” meaning that the abrasive material is contacting the displaced top surface of the hard wear resistant inserts 12 mainly. As a result, the wear rate of the softer matrix is quickly stabilized, after an initial accelerated wear, and tends to be basically equal to the wear rate of the hard inserts.

Inserts having a round shape in the plan view (see for example FIGS. 2, 12a) provide an increased compactness (A/B=1, FIGS. 2, 12a) as well as a high ricochet effect in certain specific conditions. In other conditions, the triangular, rhomboid or rectangular shaped inserts (A/B=0.4-2.5; FIG. 6) may be more suitable since they can be designed and positioned in such a way that their “shadow effect” in the direction of an abrasive mass flow is enhanced and optimized.

The inserts 12 have a vertical section in the general form of a trapezium having its minor side 18 (see FIG. 5d) directed toward the working surface of the plate 10 (see FIG. 1c). Such a configuration contributes to further anchor the inserts 12 into the matrix 14, the inserts being thus mechanically prevented against separation from the matrix 14.

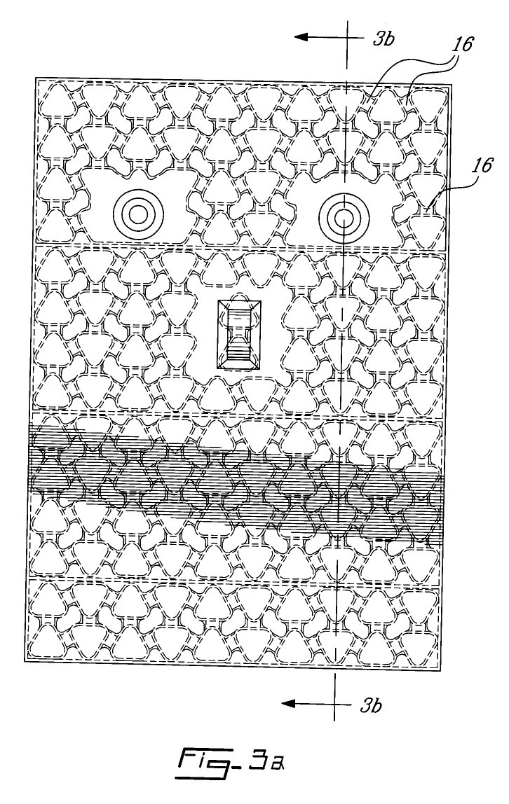

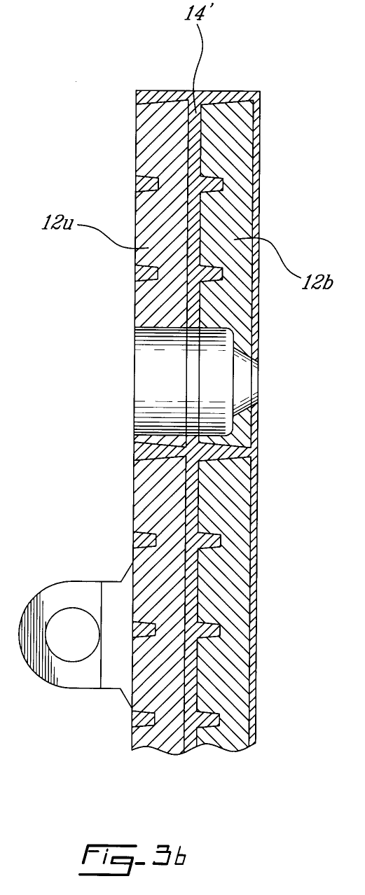

The inserts 12 may be connected together by bridges 16, as seen for example in FIGS. 3 and 5. As shown in FIGS. 5 (b), 5 (c), and 5 (d) the height (h) of the bridges 16 is inferior to the height (H) of the inserts 12. Such bridges 16, connecting inserts 12 together, protect weaker soft areas of matrix 14 between the inserts 12 against abrasive and impact wear. The height of the bridge (h) being inferior to the height of the insert (H) is also found to facilitate the flow of the matrix metal around the inserts 12 during the casting process, as will be discussed herein below.

Using bridges allows increasing the total contact area between the inserts 12 and the matrix 14 (usually 2-fold and up to 5-fold ratio), as compared to Abreco™ laminated plates or Brospec™ hard facing plates, for example, which results in a higher integrity of the casting throughout its entire thickness.

Furthermore, using bridges allows to manufacture a number of inserts as one solid member, which results in significant savings of production time and cost by dealing with one solid member only instead of a plurality of members during the molding process described hereinafter.

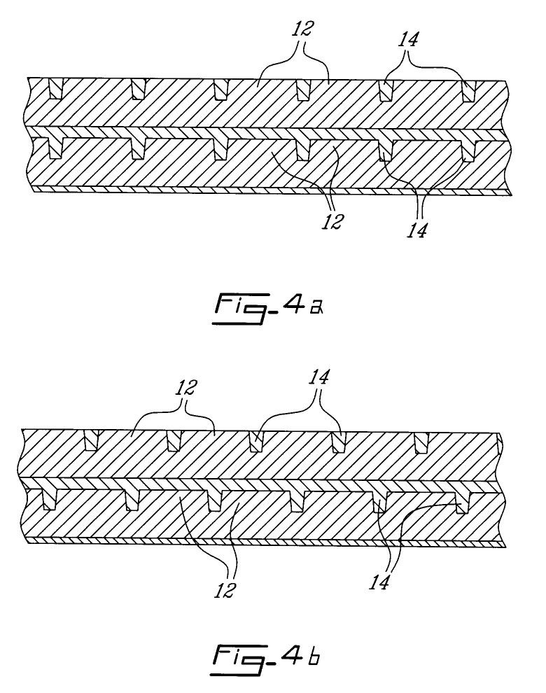

The inserts 12 are arranged to form grids located in one or more levels, as illustrated in FIGS. 1, 2, 3 and 4. In FIG. 3 (b) for example, a first bottom grid is formed by bottom inserts 12b, and a second upper grid is formed by upper inserts 12u. The grids, thus located on various levels within the thickness of the plate 10, are separated by a layer 14′ of the matrix, as shown in FIG. 3 (b). They may be coaxial in the plan view (see FIGS. 3b and 4a) or displaced laterally one versus the other in the plan view (see FIG. 4b).

Such a multilevel layout of wear resistant grids is found to drastically improve the mechanical properties of the casting, such as strength, especially when it's 3″ thick and over for example, as a result of a 3-dimensional honeycomb matrix structure that is created by occurrences of interconnecting channels throughout the thickness of the casting.

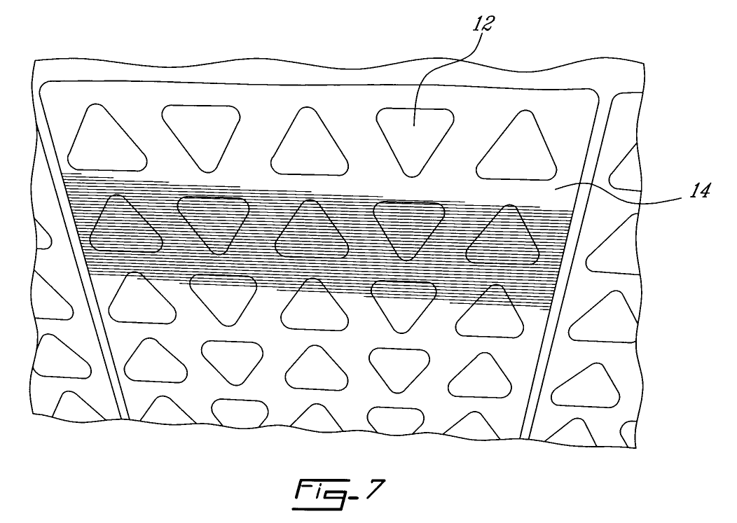

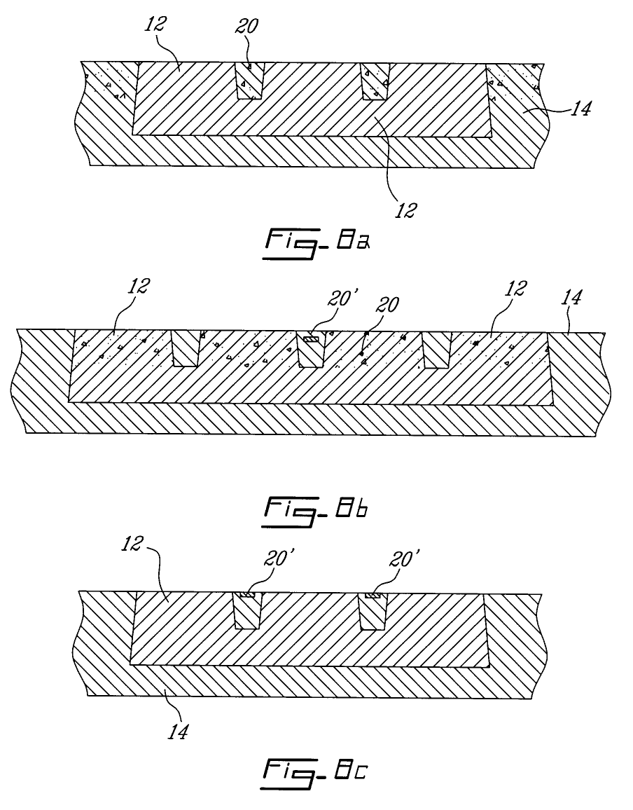

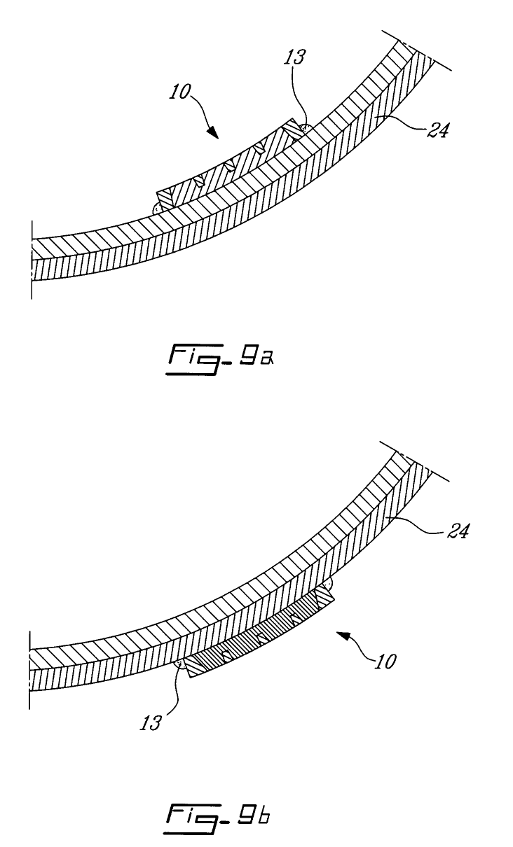

The inserts 12 may be visible when flush with the working surface of the plate (See FIG. 7).

Alternatively, they may be hidden under the working surface, the wear resistant grid being completely covered by a thin layer of the matrix ductile material. In this case, the thin layer of the matrix ductile material acts as a thermal resistance, and allows higher cooling rates during the heat treatment procedures, described hereinafter, as compared to the case of traditional wear resisting materials. Such feature has proved interesting when thick section castings (3″ thick and over) are manufactured, for example.

The plan view surface ratio, defined as the ratio of the total working surface of all inserts 12 and bridges 16 to the total working surface of the plate 10, is comprised in the range between 25% and 80%. The volumetric ratio (the volume of all inserts 12 and bridges 16 to the total volume of the plate 10) is comprised in the range between 20 and 75%.

The compound wear resistant castings, as described above, may be used to make liners for chutes, loader and excavator buckets, draglines, mills, crushers, for example, and could be used in the mining, cement, road building, construction and similar industries. Under a load, the inserts 12 distribute the action of a wear and/or impact force over a larger area, thereby increasing wear resistance, especially in cases when a combined abrasive/impact action occurs. Bridges between inserts protect softer interior spaces of the plates from excessive wear. The ductile matrix serves as integrating the inserts and allows an easy installation of wear resistant castings on surfaces to be protected, by welding, for example.

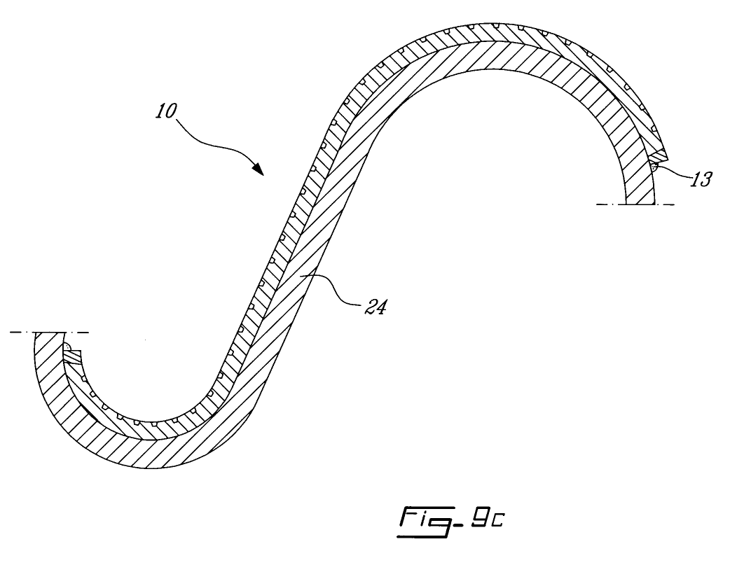

In especially harsh conditions, the casting may be additionally reinforced by adding carbide inclusions 20, such as WC—Co or TiC—WC—Co for example, at the surface (FIG. 8c) or in the volume of the insert 12 itself and/or into the spaces in between inserts (FIGS. 8b and 8a), to combine the extremely high wear resistance of the Cr, W, and V carbides with the properties of the material of the matrix.

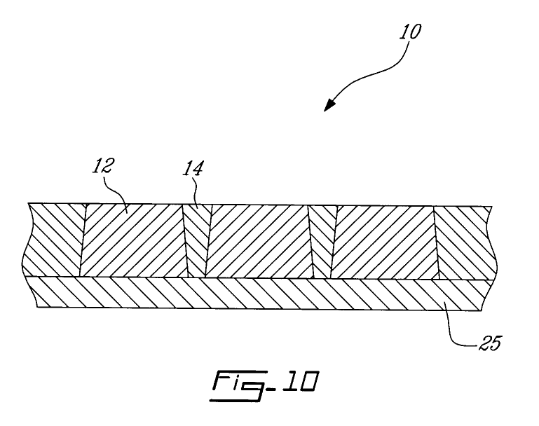

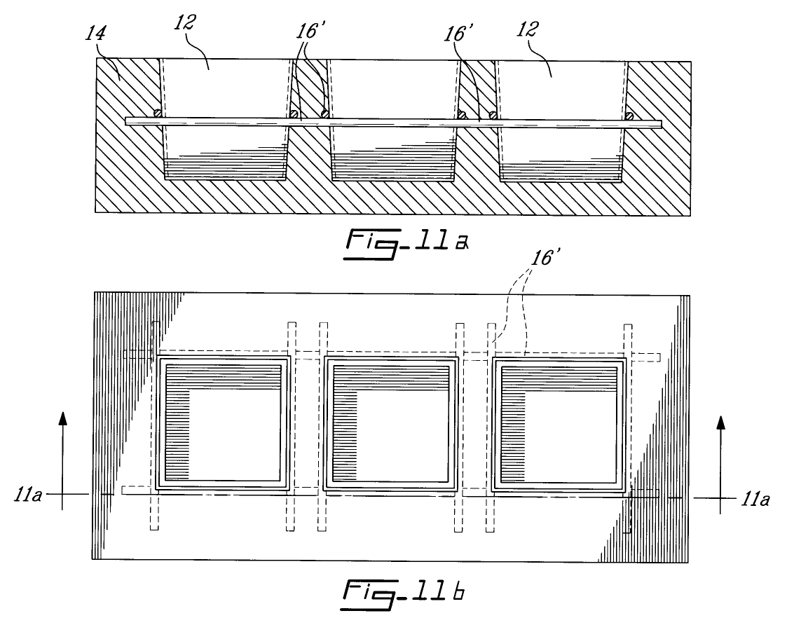

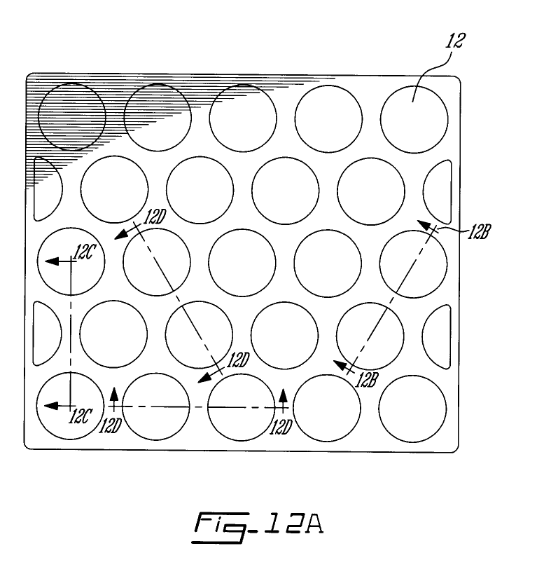

The matrix 14 may alternatively be made of a wear resistant material such as Hadfield steel or Hi-Cr cast iron, or plastic material such as rubber, polyurethane or Kevlar™ for example, instead of usual ductile ferrous alloy. In this case the weldability is provided by mild steel back plate 25 (FIG. 10) and/or steel brackets 22 (FIG. 2).

A method for making wear resistant compound castings according to an embodiment of a second aspect of the present invention will now be described.

The method generally comprises forming grids (step 100) and casting the matrix (step 120).

The grid comprises a plurality of compact elements. It is made usually out of a wear resistant cast iron comprising (mass volume, %) C between 1.7 and 3.6; Si between 0.3 and 1.7; Mn between 0.3 and 3.5; Cr between 13 and 33; Ni up to 1.0; Mo up to 1.0; Cu up to 1.0; V up to 1.0; Zr between 0.02 and 0.2; B up to 0.1. The precise chemical composition is selected as a function of specific working conditions of a given application, in particular in relation to the abrasive, corrosion or impact wear components of the application.

When the grid is cast in the mould, at least one surface of the grid is formed under the condition that: b>9.5 J/m²*K*sec ½, where b=[λ*c*γ]½*10³, λ is the specific heat conductivity of the material in W/m*K, c is the specific heat in W/kg*K and γ is the density of the material of the mould in kg/m³. Such conditions allow obtaining a target microstructure of the material of the grid and an adequate quality of the casting. As far as chromium carbide crystals are concerned, their size and dispersion in the base material as well as their crystal type are carefully controlled. Average size of chromium carbides Cr₇ C₃ is less than 6 μm.

The inserts 12 may be made of tool steel, such as, for example, D2, D4, D7, or A11, and the connecting bridges may be made of mild steel.

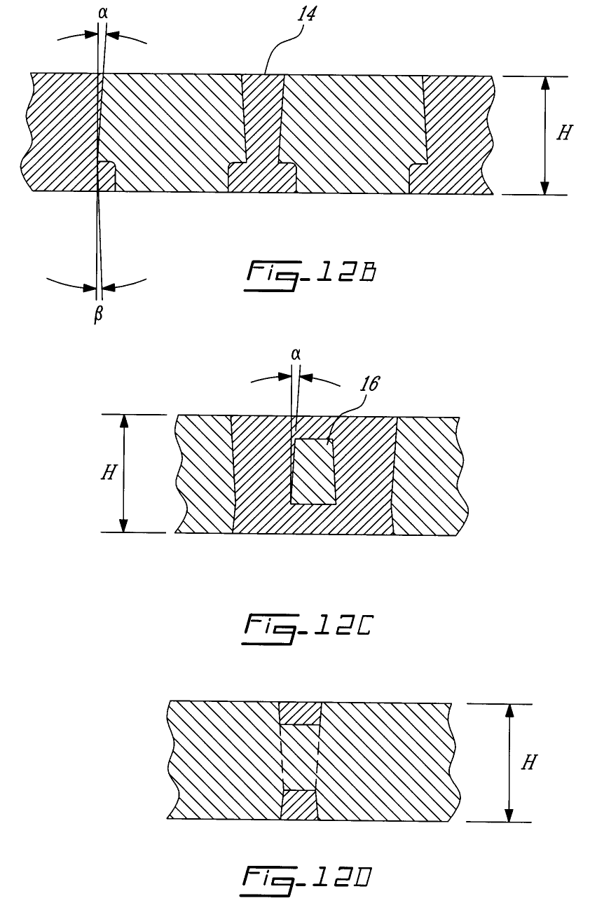

In some cases, when the grid is produced by other methods that casting, such as rolling or forging, for example, the inserts are connected to each other by mechanical means such as, for example, wire mesh (FIG. 11).

The inserts 12, the matrix 14, and the compound plate itself may have the same height H (FIG. 12). In such cases, the ratio Hᵢₙₛₑᵣₜ/Hₚₗₐₜₑ=1, and the wear resistant material of inserts is present along the whole height of the plate. The bridges 16 may then be located at about mi-height of the inserts 12 (FIGS. 12c, d, e). A ratio of the total working surface of the inserts 12 and the bridges 16 (FIGS. 12b, a, d) over a working surface of the casting (FIG. 12a) may be up to 80%. A ratio of a total volume of the inserts over a volume of the casting may be up to 75%.

In step 120, the grid thus formed is placed into a mold, together with inclusions of WC—Co, TiC—WC—Co if any, as described hereinabove, and/or steel welding brackets 22 shown in FIG. 2 and/or back plate 25 shown in FIG. 10 and intended to facilitate the welding of the casting, for example. Bridges connecting the inserts, which played the role of metallurgical gates during the grid casting, now provide intricate flow patterns for the melt matrix alloy, thereby improving anchorage of the wear resistant grid into the matrix.

The mold is then filled with a melted or plastic material, selected for the matrix according to target properties, between low carbon or low alloy steel, Mn-steel, Hi-Cr cast iron, ductile iron, Al-alloy, plastic material such as rubber, polyurethane or Kevlar™ for example.

The matrix material thus fills voids around the inserts and bridges, thereby reinforcing and completing the wear resistant casting.

When the inserts are connected with bridges, the temperature of the interface between the bridges and the matrix is drastically increased during the matrix cast, due to their relatively low cross section which improves the diffusive bond between the grid of inserts and the matrix. An optimal bond is achieved when a partial melting of the grid surface occurs, leading to truly metallurgical bond.

Using bridges also provides an additional degree of freedom in the design of the wear resistant plate, so that optimized mechanical properties of the plate may be achieved in the direction of the abrasive material flow in target applications.

The casting may further be heat treated, at a temperature comprised in the range between 820° C. and 1150° C., and subsequently cooled at a rate that prevents the creation of diffusion/transformation of the austenite in the body of the inserts, i.e. with V_{c} (T_{q}-550° C.) comprised in the range between 20 and 40° C./min, where V_{c} is the cooling rate in ° C./min, T_{q} is the quenching temperature in ° C.

In case when matrix 14 is made of a plastic material such as rubber, polyurethane or Kevlar™ for example, instead of usual ductile ferrous alloy, grids and inserts may be heat-treated as described above before they are placed into a mould.

A target microstructure of the grid after such heat treatment comprises carbide particles having a microstructure of extremely hard eutectic chromium carbides dispersed in a martensite matrix with a small amount of unstable austenite. Thus, the grid provides high wear resistance, while the more ductile steel matrix provides impact-resistance and welding properties.

In the final casting, the inserts combine optimized chemical composition, shape, and orientation, as well as a distribution throughout each casting, yielding a high resistance to intensive abrasive wear.

The present compound wear-resistant casting may be used to protect machinery surfaces from abrasive and/or impact wear, in application fields such as mining, cement, construction and other industries where crushing, grinding, and transport of abrasive materials are necessary.

In after-market applications, the present castings are fixed by welding on the surfaces to be protected, against abrasive or gouging wear by mineral ores, rocks, iron ore pellets or other abrasive materials.

The casting 10 may have a concave, convex, or concave-convex working surface, in order to be adapted to various shapes of machine parts being protected. FIG. 9a, for example, illustrates a concave casting 10 positioned by welding 13 to a concave surface 24, whereas FIG. 9b illustrates a convex casting late 10 positioned by welding 13 to a convex surface 24.

The compound castings of the present invention may be used in machine components and equipment used in open-pit mining, transportation, crushing and concentration plants as well as in coalmines, in combined abrasive/impact wear conditions. The compound castings of the present invention may be mounted on working surfaces of mining equipment, such as discharge stations of a wheel extractor in open pit coal mining, conveyer discharge devices, hoppers, digger buckets, caterpillar loader buckets, etc . . . .

The present grids show superior performance in comparison with high-Chromium cast iron (15% Cr, 3% Mo) used in current brazed laminated plates, used extensively in Canadian mining industry.

The present compound castings increase the longevity of protected surfaces by 30% to 90%, as compared to standard protection means, such as: hot rolled steel plates, railroad rails, high-manganese steel bars or wear-resistant surfaces laid by electrical deposition.

Compared to other methods of protection against intensive abrasion and impact wear, the present invention thus allows for higher design and technological flexibility, since the chemical composition and the microstructure of the inserts may be adjusted to a target values in accordance with specific wear conditions. Moreover, the impact resistance achieved is significantly higher than when using monolithic high chromium cast irons or high chromium cast irons brazed to the backing steel plates. Also, the achieved wear-resistance is significantly superior to that of low alloy steels with martensite microstructure or the high-manganese steels of Hadfield group.

Remarkably, because the present compound castings have excellent welding properties, there's no need to use expensive materials or methods for fitting it to the protected surface, as for example is in the case of martensite steels, extensively used in the mining industry.

Although the present invention has been described hereinabove by way of specific embodiments thereof, it can be modified, without departing from the spirit and nature of the subject invention as defined in the appended claims.

1. A wear resistant casting, comprising:
a matrix; and
inserts embedded in said matrix; each insert having a form such that a ratio A/B in any mutually perpendicular section that passes through the centre of mass of the insert is comprised between 0.4 and 2.5, and a distance between two inserts is at least two times smaller that a width thereof;
wherein said inserts form at least one grid.

2. The wear resistant casting of claim 1, wherein each insert has a vertical section in a form of a trapezium, a minor side of the trapezium being directed toward a working surface of the casting.

3. The wear resistant casting of claim 1, wherein said inserts are connected together by bridges.

4. The wear resistant casting of claim 1 3, wherein said inserts are connected together by bridges, a height of said bridges is inferior to a height of said inserts.

5. The wear resistant casting of claim 1, wherein a ratio of a total working surface of the inserts over a working surface of the casting is comprised in a range between 25 to 80%.

6. The wear resistant casting of claim 1, wherein said inserts are connected together by bridges, a height of said bridges is inferior to a height of said inserts, a ratio of the total working surface of the inserts and the bridges over a working surface of the casting is comprised in a range between 25 to 80%.

7. The wear resistant casting of claim 1, wherein a ratio of a total volume of the inserts over a volume of the casting is comprised in a range between 20 and 75%.

8. The wear resistant casting of claim 1, wherein said inserts are connected together by bridges, a height of said bridges is inferior to a height of said inserts, a ratio of a total volume of the inserts and the bridges over a volume of the casting is comprised in a range between 20 and 75%.

9. The wear resistant casting of claim 1, wherein said inserts are formed in a plan view as ones of: circles, triangles, squares, rectangles, Y-, and T-forms.

10. The wear resistant casting of claim 1, comprising inserts of a shape formed by a combination of at least one of: circles, triangles, squares, rectangles, Y- and T-forms.

11. The wear resistant casting of claim 1, wherein said inserts form at least two grids, said grids being located on at least two levels.

12. The wear resistant casting of claim 1 11, wherein said inserts form at least two grids, said grids being located on at least two levels, said at least two grids are separated by a layer of the matrix along a height of the casting.

13. The wear resistant casting of claim 11, wherein said grids are one of: i) coaxial along a height of the casting and ii) displaced laterally one versus the other along a height of the casting.

14. The wear resistant casting of claim 1, having one of: i) a concave; ii) a convex and iii) a concave-convex form.

15. The wear resistant casting of claim 1, wherein said inserts are hidden under a working surface of the casting.

16. The wear resistant casting of claim 1, wherein said inserts are flush with a working surface of the casting.

17. The wear resistant casting of claim 1, wherein said at least one grid is made of wear resistant cast iron comprising, in % mass volume: C between 1.7 and 3.6; Si between 0.3 and 1.7; Mn between 0.3 and 3.5; Cr between 13 and 33; Ni up to 1.0; Mo up to 1.0; Cu up to 1.0; V up to 1.0; Zr between 0.02 and 0.2; B up to 0.1.

18. The wear resistant casting of claim 1, further comprising, at a perimeter thereof, at least one steel insert, embedded in said matrix.

19. The wear resistant casting of claim 1, further comprising carbide inclusions.

20. The wear resistant casting of claim 1, wherein said matrix is made in a ductile ferrous alloy.

21. The wear resistant casting of claim 1, wherein said matrix is made in a wear resistant ferrous alloy

22. The wear resistant casting of claim 1, wherein said matrix is made in one of: rubber, polyurethane and Kevlar™.

23. The wear resistant casting of claim 21, further comprising at least one of: i) steel brackets and ii) steel back plate.

24. The wear resistant casting of claim 1, wherein said inserts are connected together by bridges, said inserts comprise one of: tool steel, WC—Co, TiC—WC—Co, and said bridges comprise mild steel.

25. A method for manufacturing wear resistant plates, comprising the steps of:
forming at least one grid of compact elements; and
inserting the at least one grid into a jacket;
wherein said forming at least one grid comprises forming compact elements having a form such that a ratio A/B in any mutually perpendicular section that passes through the centre of mass of the insert is comprised between 0.4 and 2.5, and a distance C between two insert is at least two times smaller that a width A, B thereof.

26. The method of claim 25, wherein said forming at least one grid comprises casting compact elements comprising, in % mass volume: C between 1.7 and 3.6; Si between 0.3 and 1.7; Mn between 0.3 and 3.5; Cr between 13 and 33; Ni up to 1.0; Mo up to 1.0; Cu up to 1.0; V up to 1.0; Zr between 0.02 and 0.2; B up to 0.1.

27. The method of claim 25, wherein said step of forming at least one grid comprises casting in a mould at least one surface of the grid under the conditions that: b>9.5 J/m²*K*sec ½, where b=[λ*c*γ]½*10³, λ is the specific heat conductivity in W/m*K, c is the specific heat in W/kg*K and γ is the density in kg/m³ of a material of the mould.

28. The method of claim 25, wherein said step of forming at least one grid comprises casting compact elements and bridges connecting the compact elements.

29. The method of claim 25, wherein said step of inserting the compact elements into a jacket comprises placing the compact elements into a mould and pressing a ductile material in the mould.

30. The method of claim 25, wherein said step of inserting the compact elements into a jacket comprises placing the compact elements into a mould and pressing a ductile material reinforced with carbide inclusions.

31. The method of claim 25, wherein said step of forming at least one grid comprises casting at least one insert reinforced with carbide inclusions.

32. The method of claim 25, wherein said step of forming at least one grid comprises forming compact elements and bridges connecting the compact elements, the compact elements being made of one of: tool steel, WC—Co, TiC—WC—Co, and the bridges connecting the compact elements being made of mild steel.

33. The method of claim 25, further comprising the step of heating and of force cooling.

34. The method of claim 25, further comprising the step of heating at a temperature comprised in a range between 820° C. and 1150° C., and the step of force cooling.

35. The method of claim 33, further comprising the step of heating and the step of force cooling with Vc (Tq-550° C.) comprised in the range between 20 and 40° C./min, where Vc is the cooling rate in ° C./min, Tq is the quenching temperature in ° C.

36. The wear resistant casting of claim 22, further comprising at least one of: i) steel brackets and ii) steel back plate.
